(19) United States
(12) Patent Application Publication
(10) Pub. No.: US 2021/0245243 A1
(43) Pub. Date: Aug. 12, 2021

(54) METHODS FOR THE CONTROL OF GRAIN GROWTH IN THE SINTERING OF POWDERED MATERIALS VIA NANO-PARTICLE JETTING

(71) Applicant: HONEYWELL INTERNATIONAL INC., Morris Plains, NJ (US)

(72) Inventors: Hector Alonso Peralta-Duran, Avondale, AZ (US); Harry Kington, Scottsdale, AZ (US)

(73) Assignee: HONEYWELL INTERNATIONAL INC., Morris Plains, NJ (US)

(21) Appl. No.: 16/787,388

(22) Filed: Feb. 11, 2020

(51) Int. Cl. B22F 3/00; B29C 64/112; B28B 1/00; B33Y 10/00; B33Y 70/00

(52) U.S. Cl. CPC B22F 3/008; B29C 64/112; B22F 2304/05; B33Y 10/00; B33Y 70/00; B28B 1/001

(57) ABSTRACT

A method for controlling grain growth in articles of manufacture produced using nano-particle jetting additive manufacturing processes includes the steps of; providing or obtaining nanoparticles of a bulk material, providing or obtaining nanoparticles of a dopant material different from the bulk material, supplying the bulk material and the dopant material to a nano-particle jetting apparatus, and using the nano-particle jetting apparatus, building-up the article of manufacture in a layer-by-layer manner. Each layer includes a mixture of the bulk material particles and the dopant material particles. Furthermore, the method includes sintering the article of manufacture. During sintering, the presence of the dopant material mixed with the bulk material moderates the grain growth of the bulk material.

### TECHNICAL FIELD

The present disclosure generally relates to the manufacture of components using additive manufacturing techniques, in particular nano-particle jetting. More particularly, the particularly, the present disclosure relates to methods for the control of grain growth in the sintering of powdered materials via nano-particle jetting.

### BACKGROUND

Control in the size of grain growth in sintered articles of manufacture is important in terms of the ultimate material properties of the articles. For example, by tightly controlling grain growth, articles may be manufactured with increased strength, thereby requiring a smaller article to achieve the same strength-function. Size and weight considerations, in terms of strength, are important to industries such as the gas turbine engine industry, when lighter weights yield benefits in terms of operational efficiency.

For example, typical gas turbine engines include one or more disks and rotor shafts supported by bearings which, in turn, are supported by load-bearing members such as annular frames, struts, and the like. Each frame includes an annular casing spaced radially outwardly from an annular hub and a plurality of circumferentially spaced apart struts extending therebetween which direct a pre-determined air flow downstream from the frame. The struts may be integrally formed with the casing and hub in a common body, for example, or may be suitably bolted thereto. These load-bearing components facilitate providing structural support to the overall engine, and structural rigidity for supporting the rotor shaft to facilitate minimizing deflections of the shaft during engine operation. The loads applied to the load bearing components by the rotating disks can be reduced by reducing the weight and moment of inertia of the disks by designing them with materials of the highest possible strength optimized for every location of the rotating body.

Given the relationship between weight and efficiency of engine operation, greater operational efficiencies could be realized if smaller and lighter-weight components could be used for rotating as well as for these load-bearing members, which, according to their function, are required to have significant strength in order withstand the operational forces of the engine. Hence, there is a need for improved high-strength, light-weight materials and components. It would additionally be desirable if such materials and components could be manufactured using modern, rapid fabrication techniques, such as additive manufacturing. Furthermore, other desirable features and characteristics of the manufacturing methods disclosed herein will become apparent from the subsequent detailed description and the appended claims, taken in conjunction with the accompanying drawings and the preceding background.

### BRIEF SUMMARY

This summary is provided to describe select concepts in a simplified form that are further described in the detailed description. This summary is not intended to identify key or essential features of the claimed subject matter, nor is it intended to be used as an aid in determining the scope of the claimed subject matter.

In one embodiment, a method for controlling grain growth in articles of manufacture produced using nano-particle jetting additive manufacturing processes includes the steps of; providing or obtaining nanoparticles of a bulk material, providing or obtaining nanoparticles of a dopant material different from the bulk material, supplying the bulk material and the dopant material to a nano-particle jetting apparatus, and using the nano-particle jetting apparatus, building-up the article of manufacture in a layer-by-layer manner. Each layer includes a mixture of the bulk material particles and the dopant material particles. Furthermore, the method includes sintering the article of manufacture. During sintering, the presence of the dopant material mixed strategically for the desired location with the bulk material moderates the grain growth of the bulk material.

In another embodiment, a method for controlling grain growth in gas turbine engine component articles of manufacture produced using nano-particle jetting additive manufacturing processes includes the steps of providing or obtaining nanoparticles of a metal or metal alloy bulk material suspended in a liquid carrier and providing or obtaining nanoparticles of a ceramic dopant material suspended in the liquid carrier. Each of the nanoparticles of the bulk material and the dopant material have a particle size of from about 5 nanometers to about 500 nanometers. The method further includes the step of supplying the bulk material and the dopant material to a nano-particle jetting apparatus either as a mixture of the bulk material and the dopant material or to respective subsets of printing heads of the nano-particle jetting apparatus. The step of supplying is performed so as to achieve a weight ratio of the bulk material to the dopant material of from about 100:1 to about 2:1. The method further includes the step of using the nano-particle jetting apparatus, building-up the article of manufacture in a layer-by-layer manner. Each layer includes a mixture of the bulk material particles and the dopant material particles, and the carrier liquid evaporates after depositing of a respective layer. Still further, the method includes the step of sintering the article of manufacture at a temperature below the melting point of the bulk material. During sintering, the presence of the dopant material mixed with the bulk material moderates the grain growth of the bulk material.

In yet another embodiment, a method for controlling grain growth in articles of manufacture produced using nano-particle jetting additive manufacturing processes includes the steps of: providing or obtaining nanoparticles of a plurality of elements forming a multiple principal element alloy; supplying the nanoparticles of the plurality of elements to a nano-particle jetting apparatus; using the nano-particle jetting apparatus, building-up the article of manufacture in a layer-by-layer manner, wherein each layer comprises a mixture of the particles of the plurality of elements; and sintering the article of manufacture. During sintering, the presence of the plurality of elements moderates the grain growth of ones of the plurality of elements with respect to others of the plurality of elements, thereby forming an equi-component multiple principal element alloy.

### BRIEF DESCRIPTION OF THE DRAWINGS

The present invention will hereinafter be described in conjunction with the following drawing figures, wherein like numerals denote like elements, and wherein:

FIG. 1 is a simplified cross section side view of a gas turbine engine, according to an exemplary embodiment;

FIG. 2 illustrates a primary or bulk material having dopant material inclusions therein in accordance with exemplary embodiments;

FIG. 3 illustrates an equi-component multiple principal element alloy, in accordance with various embodiments;

FIG. 4 illustrates a turbine engine component manufactured using the bulk material having dopant material inclusions of FIG. 2; and

FIG. 5 illustrates a turbine engine component manufactured using the equi-component multiple principal element alloy of FIG. 3.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, or 0.5% of the stated value. Unless otherwise clear from the context, all numerical values provided herein are modified by the term “about.”

Before proceeding with the detailed description, it is to be appreciated that the described embodiments are not limited to use in conjunction with a particular type of turbine engine or mechanical device. Thus, although the present embodiments are, for convenience of explanation, depicted and described as being implemented in a multi-spool turbofan gas turbine jet engine, it will be appreciated that it can be implemented in various other types of turbine engine or mechanical devices, and in various other systems and environments. Moreover, although the embodiments of the inventive subject matter are described as being implemented into a compressor or turbine section of the engine, it will be appreciated that the embodiments of the inventive subject matter may alternatively be used in any other section of the engine that may need high strength components.

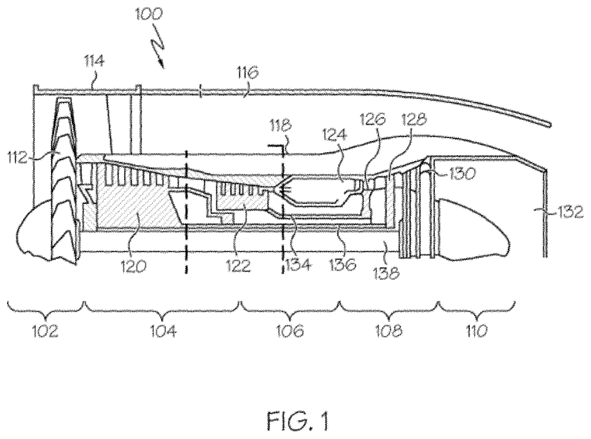

As initially noted, gas turbine engines include a variety of load-bearing components that would benefit from being lighter in weight while still possessing the same strength to ensure safe mounting and operation of the engine. For example, FIG. 1 is a simplified, schematic of a gas turbine engine 100, according to an embodiment. The gas turbine engine 100 generally includes an intake section 102, a compressor section 104, a combustion section 106, a turbine section 108, and an exhaust section 110. The intake section 102 includes a fan 112, which is mounted in a fan case 114. The fan 112 draws air into the intake section 102 and accelerates it. A fraction of the accelerated air exhausted from the fan 112 is directed through a bypass section 116 disposed between the fan case 114 and an engine bypass duct 118, and provides a forward thrust. The remaining fraction of air exhausted from the fan 112 is directed into the compressor section 104.

The compressor section 104 includes an intermediate-pressure compressor 120 and a high-pressure compressor 122. The intermediate-pressure compressor 120 raises the pressure of the air directed into it from the fan 112, and directs the compressed air into the high-pressure compressor 122. The high-pressure compressor 122 compresses the air still further and directs the high-pressure air into the combustion section 106. In the combustion section 106, which includes an annular combustor 124, the high-pressure air is mixed with fuel and combusted. The combusted air is then directed into the turbine section 108.

The turbine section 108 includes a high-pressure turbine 126, an intermediate-pressure turbine 128, and a low-pressure turbine 130 disposed in axial flow series. The combusted air from the combustion section 106 expands through the turbines 126, 128, 130 causing each to rotate. The air is then exhausted through a propulsion nozzle 132 disposed in the exhaust section 110, providing additional forward thrust. As each turbine 126, 128, 130 rotates, each drives equipment in the engine 100 via concentrically disposed shafts or spools. Specifically, the high-pressure turbine 126 drives the high-pressure compressor 122 via a high-pressure shaft 134, the intermediate-pressure turbine 128 drives the intermediate-pressure compressor 120 via an intermediate-pressure shaft 136, and the low-pressure turbine 130 drives the fan 112 via a low-pressure shaft 138.

As new and more efficient designs of the various components of gas turbine engine 100 are developed, it becomes important to have the ability to rapidly produce such parts for testing. Moreover, in terms of eventual commercial manufacture, fabrication technologies that reduce time and costs are beneficial. Accordingly, interest has grown in recent years in terms of additive manufacturing technologies, which promise the ability to provide increased manufacturing speeds at reduced costs.

The additive manufacturing technology upon which the present disclosure is based in known as nano-particle jetting, or nano-particle jet printing. Nano-particle jetting involves the use of inkjet printing heads or spray nozzles for dispensing an ink. The inkjet heads normally dispense the ink layer-by-layer, dispensing subsequent layers on previously dispensed layers.

The ink includes a dispersion of solid particles of any required material, for example metals, metal oxides, oxides, metal carbides, carbides, metal alloys, inorganic salts, polymeric particles, etc., in volatile carrier liquid. The particles are of nano-size (for example, from about 5 to about 500 nanometers, or about 10 to about 250 nanometers) as required to maintain the required spatial resolution during printing, maintain the required material character (after sintering), or to satisfy limitations of a dispensing head.

The particles are dispersed in a carrier liquid, also referred to as a “carrier” or “solvent”. A dispersing agent (often call dispersant) assist in dispersing the particles in the liquid. According to one embodiment, the liquid should evaporate immediately after printing so that the succeeding layer is dispensed on solid material below. Hence, the temperature of an upper layer of the object during printing should be comparable with the boiling temperature of the carrier. In another embodiment, the temperature of the upper printed layer is much higher than the boiling temperature of the liquid carrier, encouraging thereby the evaporation of other organic materials like dispersants or various additives in the carrier.

During nano-particle jetting operations, a 3D object (for example, a load-bearing component of gas turbine engine 100) is typically constructed layer-by-layer on a substrate or tray. The tray is typically heated. The object is printed in the plane of the X-Y axis, and a newly formed layer is built along the Z-axis during every printing pass. Ink is supplied or contained in a printing head. An optional radiation source and/or cooling fan can be used to assist with temperature control of the newly printed layer and/or 3D object body. An optional leveling roller can be used during printing to smooth the surface of the newly formed layer and/or the top surface (outermost surface along the Z-axis) of the 3D object body.

Sintering may be performed upon deposition of the final layer. A net-shape or near-net shape final article results after the final layer and/or final sintering is completed. As used in the present disclosure, “sintering” should be broadly construed to mean a method of forming a solid mass of material by heat and/or pressure without melting the entire mass to the point of liquefaction. The atoms in the materials diffuse across the boundaries of the particles, fusing the particles together and creating one solid piece. The sintering temperature is typically less than the melting point of the bulk material. In some embodiments, liquid-state sintering is used, in which some but not all of the volume is in a liquid state. When sintering or another heat treatment is utilized, the heat or energy may be provided by electrical current, electromagnetic energy, chemical reactions (including formation of ionic or covalent bonds), electrochemical reactions, pressure, or combinations thereof.

As initially noted above, in order to obtain the optimum strength profile for a particular material, it is necessary to control the grain growth of the deposited particles during this sintering process. Grain growth as used herein refers to both the size of the grains as well as their orientation with respect to one another. Embodiments of the present disclosure employ the use of a secondary material or “dopant” material to help control the grain growth of the primary or bulk material. The dopant material may be provided as nano-particles, and may be deposited during the nano-particle printing process at the same time as the bulk (primary) material nano-particles, for example by using different printing heads/nozzles or by pre-mixing the primary and secondary materials at an appropriate ratio. Greater detail regarding grain growth control using a dopant material is provided below. Both the bulk and dopant materials include nano-particles of the size range as described above, and are utilized in a nano-particle jetting apparatus in the manner as described above (e.g., dispersed in carrier, dispensed through a printing head, built-up in a layer-by-layer manner, etc.)

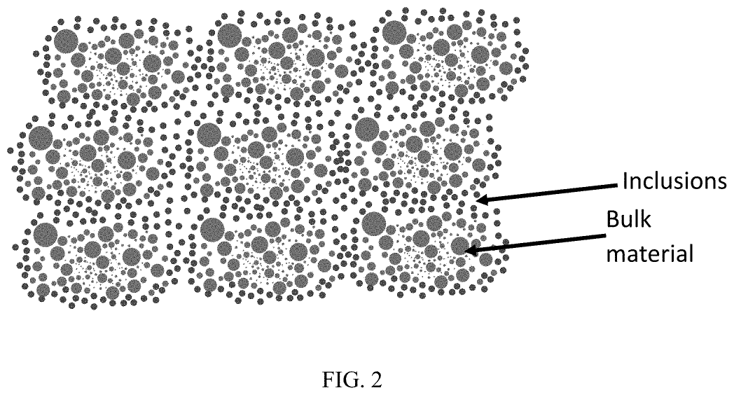

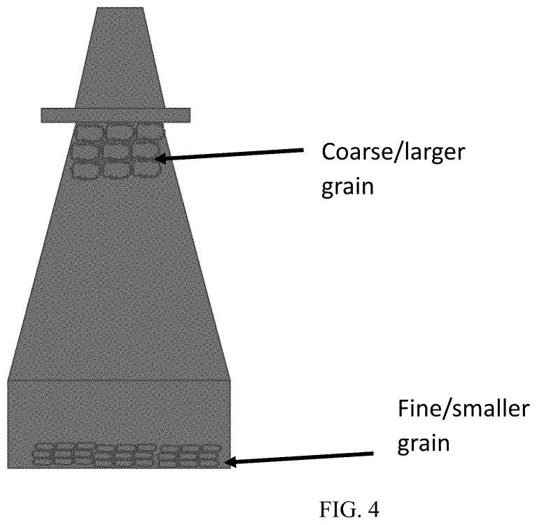

In particular, the use of a dopant material to control the grain growth of the bulk material in terms of grain size is realized on the basis of three-dimensional nanoparticle architectures of the dopant within bulk material microstructures. These architectures may significantly improve the material properties by impeding, blocking, or redirecting dislocation motion in specific directions during grain growth, which occurs during the sintering process(es). In general, the material properties that may be controlled as a result of grain growth include, for example, yield strength, fatigue, and creep, among others. FIG. 2 provides an illustrates of a bulk material microstructure having dopant material inclusions, whereas FIG. 4 illustrates a turbine engine component manufactured so include such a microstructure.

In accordance with the present disclosure, various material combinations are possible. In some embodiments, the bulk powder particles are ceramic and the dopant nanoparticles are ceramic. In some embodiments, the bulk powder particles are ceramic and the nanoparticles are metallic. In some embodiments, the bulk powder particles are polymeric and the nanoparticles are metallic, ceramic, or carbon-based. In some embodiments, the bulk powder particles are glass and the nanoparticles are metallic. In some embodiments, the bulk powder particles are glass and the nanoparticles are ceramic. In some embodiments, the bulk powder particles are ceramic or glass and the nanoparticles are polymeric or carbon-based, and so on. The selection of the coating/powder composition will be dependent on the desired properties and should be considered on a case-by-case basis. Someone skilled in the art of material science or metallurgy will be able to select the appropriate materials for the intended purpose or implementation of the manufactured article. Regardless of the embodiment, the bulk powder particles are not surface-functionalized with the dopant nanoparticles; rather, the jetting process is performed on the basis of a mixture of the bulk and dopant materials.

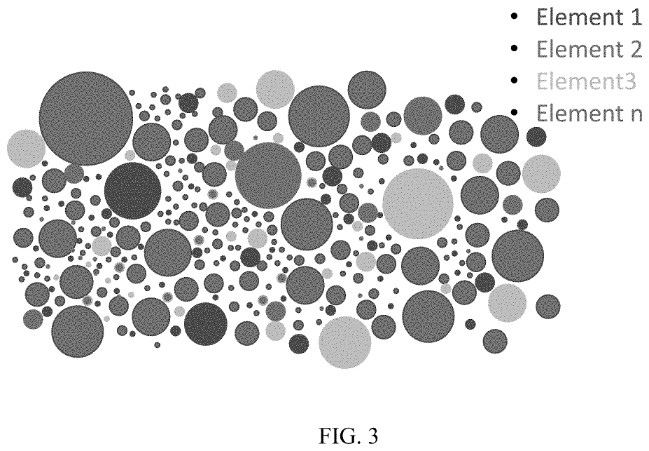

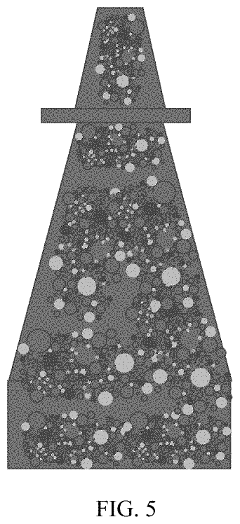

In other embodiments, the techniques described herein may be used in connection with an equi-component multiple principal element alloy. Here, various elements of the alloys are dispersed throughout the component, with each element having a different grain size. That is, during sintering, the presence of the plurality of elements moderates the grain growth of ones of the plurality of elements with respect to others of the plurality of elements, resulting in some being relatively larger and some being relatively smaller. FIG. 3 illustrates such an embodiment an equi-component multiple principal element alloy microstructure, whereas FIG. 5 illustrates a turbine engine component manufactured so include such a microstructure.

Upon sintering, grain growth control may be realized by for example, upon sintering, the dopant nanoparticles serve to control the size of the grain by forming a corral which controls the maximum grain size that can develop by preventing the grain on one size of the fence from crossing to the other side, thereby producing a controlled grained structure of the bulk material.

The relative proportions of the as-deposited bulk and dopant materials are dependent on the particular materials employed, and the desired material properties of the additively-manufactured article. In one embodiment, a weight ratio of the bulk material to the dopant material may be from about 100:1 to about 2:1, for example from about 100:1 to about 5:1, such as from about 50:1 to about 2:1, or about 50:1 to about 5:1, or about 20:1 to about 2:1, or about 20:1 to about 5:1. Other ranges are possible. The ratio used may be controlled in one of several manners. For example, the materials may be pre-mixed at the appropriate ratio and the numerous printing heads of the nano-particle jetting apparatus may all be supplied with the mixture. Alternatively, the materials may be maintained separately, and some of the printing heads may be supplied with the bulk material, whereas other printing heads may be supplied with the dopant materials, wherein the number of respective printing heads is selected so as to achieve the desired ratio of materials in the as-deposited layer.

In some embodiments, it may be desirable to produce an article that has different strength characteristics at different portions of the article. As such, in these embodiments, the relative amounts of the bulk material and the dopant material may be varied throughout the article. In should be appreciated that varying the relative amounts of the materials will affect the grain growth control, which will in turn affect the material properties. For example, some of the printed layers may employ a ratio of about 40:1 whereas other layers may employ a ratio of about 30:1. This is just an example, and a practically infinite number of combinations of various material ratios may be employed throughout the building (printing) process at the various layers.

Other variations are also possible for producing an article that has different strength characteristics at different portions of the article. For example, in an alternative embodiment, the bulk material and/or the dopant material may be varied from layer to layer throughout the build process. In should be appreciated that varying the types of the materials will affect the grain growth control, which will in turn affect the material properties. For example, some layers may utilize a first bulk material and a first dopant material. Other layers may utilize a second bulk material and the first dopant material. Other layers may utilize the first bulk material and a second dopant material. Still other layers may utilize the second bulk material and the second dopant material. As can be appreciated, a practically infinite number of combinations of various bulk/dopant materials may be employed throughout the building (printing) process at the various layers and various types of alloys such as equi-component multiple principal element alloys. Moreover, the use of differing materials in combination with differing ratios of the materials may be utilized to achieve a desired strength profile throughout the manufactured article.

Accordingly, the present disclosure has provided various embodiments of methods for the control of grain growth in the sintering of powdered materials via nano-particle jetting. A bulk material and a dopant material are provided to the nano-particle jetting apparatus, and both materials are applied to a substrate in a layer-by-layer fashion to build-up an article. Upon sintering of the article, the dopant material functions to moderate the grain growth of the bulk material to produce an article that has superior material properties, such as strength. Articles produced in accordance with the present disclosure may be suitable for use as load-bearing components of a gas turbine engine, wherein the weight reduction achieved in such components may lend greater efficiencies to the operation of the gas turbine engine without compromising structural integrity.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

What is claimed is:

1. A method for controlling grain growth in articles of manufacture produced using nano-particle jetting additive manufacturing processes, the method comprising the steps of:
providing or obtaining nanoparticles of a bulk material;
providing or obtaining nanoparticles of a dopant material different from the bulk material;
supplying the bulk material and the dopant material to a nano-particle jetting apparatus;
using the nano-particle jetting apparatus, building-up the article of manufacture in a layer-by-layer manner, wherein each layer comprises a mixture of the bulk material particles and the dopant material particles; and
sintering the article of manufacture, wherein during sintering, the presence of the dopant material mixed with the bulk material moderates the grain growth of the bulk material.

2. The method of claim 1, wherein the article of manufacture is a turbine engine component.

3. The method of claim 1, wherein the turbine engine component is a load-bearing component.

4. The method of claim 1, wherein the bulk material is selected from the group consisting of: metals, metal oxides, oxides, metal carbides, carbides, metal alloys, inorganic salts, and polymeric particles.

5. The method of claim 1, wherein the dopant material is selected from the group consisting of: metals, metal oxides, oxides, metal carbides, carbides, metal alloys, inorganic salts, and polymeric particles.

6. The method of claim 1, wherein the bulk material is a metal or metal alloy and the dopant material is a ceramic.

7. The method of claim 1, wherein a weight ratio of the bulk material to the dopant material is from about 1000:1 to about 2:1.

8. The method of claim 7, wherein a weight ratio of the bulk material to the dopant material is from about 500:1 to about 5:1.

9. The method of claim 1, wherein the bulk material and the dopant material have a particle size of from about 5 nanometers to about 500 nanometers.

10. The method of claim 1, wherein the bulk material and the dopant material particles are suspended in a carrier liquid.

11. The method of claim 10, wherein the carrier liquid is volatile and evaporates upon depositing a layer by the nano-particle jetting apparatus.

12. The method of claim 1, wherein sintering is performed at a temperature below the melting point of either the bulk material or the dopant material, whichever melting point is lower.

13. The method of claim 1, wherein sintering is performed after deposition of all layers of the article of manufacture.

14. The method of claim 1, wherein the bulk material is not functionalized by the dopant material.

15. The method of claim 1, wherein supplying the bulk and dopant materials comprises supplying a mixture of the bulk and dopant materials.

16. The method of claim 1, wherein supplying the bulk and dopant materials comprises supplying the bulk material to a first subset of printing heads of the nano-particle jetting apparatus and supplying the dopant material to a second subset of the printing heads of the nano-particle jetting apparatus.

17. The method of claim 1, further comprising varying a ratio of the dopant and bulk materials during the step of building-up the article of manufacture.

18. The method of claim 1, further comprising varying a material composition of either or both of the dopant and bulk materials during the step of building-up the article of manufacture as a function of the location on or in the component.

19. A method for controlling grain growth in gas turbine engine component articles of manufacture produced using nano-particle jetting additive manufacturing processes, the method comprising the steps of:
providing or obtaining nanoparticles of a metal or metal alloy bulk material suspended in a liquid carrier;
providing or obtaining nanoparticles of a ceramic dopant material suspended in the liquid carrier, wherein each of the nanoparticles of the bulk material and the dopant material have a particle size of from about 5 nanometers to about 500 nanometers;
supplying the bulk material and the dopant material to a nano-particle jetting apparatus either as a mixture of the bulk material and the dopant material or to respective subsets of printing heads of the nano-particle jetting apparatus, wherein the step of supplying is performed so as to achieve a weight ratio of the bulk material to the dopant material of from about 100:1 to about 2:1;
using the nano-particle jetting apparatus, building-up the article of manufacture in a layer-by-layer manner, wherein each layer comprises a mixture of the bulk material particles and the dopant material particles, and wherein the carrier liquid evaporates after depositing of a respective layer; and
sintering the article of manufacture at a temperature below the melting point of the bulk material, wherein during sintering, the presence of the dopant material mixed with the bulk material moderates the grain growth of the bulk material.

20. A method for controlling grain growth in articles of manufacture produced using nano-particle jetting additive manufacturing processes, the method comprising the steps of:
providing or obtaining nanoparticles of a plurality of elements forming a multiple principal element alloy;
supplying the nanoparticles of the plurality of elements to a nano-particle jetting apparatus;
using the nano-particle jetting apparatus, building-up the article of manufacture in a layer-by-layer manner, wherein each layer comprises a mixture of the particles of the plurality of elements; and
sintering the article of manufacture, wherein during sintering, the presence of the plurality of elements moderates the grain growth of ones of the plurality of elements with respect to others of the plurality of elements, thereby forming an equi-component multiple principal element alloy.
